(19) United States
(12) Patent Application Publication
(10) Pub. No.: US 2003/0148797 A1
(43) Pub. Date: Aug. 7, 2003

(54) USB charging cable for mobile telephone

(76) Inventor: Yea Yen Huang, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/198,145

(22) Filed: Jul. 19, 2002

(30) Foreign Application Priority Data
Feb. 1, 2002 (TW) 091201185

(51) Int. Cl. H04M 1/00; H04B 1/38

(52) U.S. Cl. 455/573; 455/572

(57) ABSTRACT

A USB charging cable for mobile telephone is constructed to include a USB connector adapted for connecting to the USB port of an electronic apparatus to receive power supply from the USB port and to rectify the power supply into a voltage level acceptable to a mobile telephone, and a charging cable adapted for connecting the USB connector to a mobile telephone to charge the mobile telephone with the power supply outputted from the USB.

### BACKGROUND OF THE INVENTION

1. Field of the Invention

The present invention relates to a charging cable adapted for charging the battery of a mobile telephone and, more particularly to a USB (Universal Serial Bus) charging cable adapted for charging the battery of a mobile telephone with the power supply obtained from the USB port of an electronic apparatus.

2. Description of the Related Art

A USB (Universal Serial Bus) plug is connectable to the USB port of a desk-top computer, notebook computer, hub, or any of a variety of electronic apparatus, comprising four lines, namely, two signal lines for data transmission and two power lines for the transmission of low voltage (about 5V) and low current (About 500 μA).

Further, mobile telephone as well as computer users are popular. Most computer users have a mobile telephone. However, the battery power of a mobile telephone cannot work for long. When battery low, the battery of the mobile telephone must be replaced or recharged. According to conventional designs, a mobile telephone cannot be directly connected to a computer and charged with the power supply of the computer.

### SUMMARY OF THE INVENTION

The present invention has been accomplished under the circumstances in view. It is therefore the main object of the present invention to provide a USB charging cable for mobile telephone, which is specifically designed for connecting a mobile telephone to the USB port of an electronic apparatus for enabling the battery of the mobile telephone to be charged with the power supply of the electronic apparatus. To achieve this and other objects of the present invention, the USB charging cable for mobile telephone comprises a USB connector adapted for connecting to the USB port of an electronic apparatus to receive the power supply of the electronic apparatus and to rectify the received power supply into a mobile telephone workable voltage level, and a charging cable adapted for connecting the USB connector to the power jack of a mobile telephone for enabling the battery of the mobile telephone to be charged with the power supply received from the USB connector.

### BRIEF DESCRIPTION OF THE DRAWINGS

FIG. 1 is an exploded view of a USB charging cable for mobile telephone according to the present invention.

### DETAILED DESCRIPTION OF THE PREFERRED EMBODIMENT

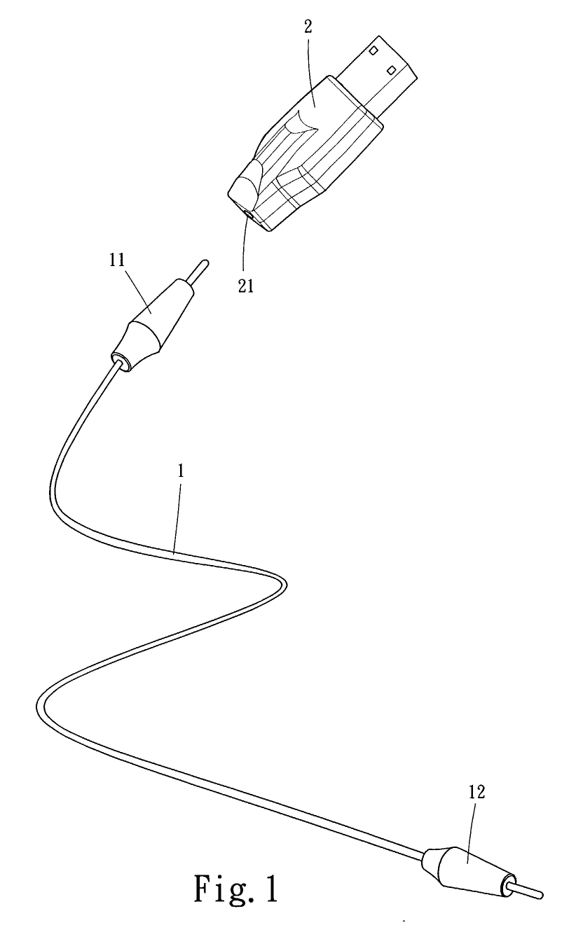

Referring to FIG. 1 a USB charging cable for mobile telephone is shown comprised of a charging cable 1, and a USB connector 2. The charging cable 1 comprises a first connector 1 disposed at one end and adapted for connecting to the USB connector 2, and a second connector 12 disposed at the other end and adapted for connecting to the power jack of a mobile telephone. The USB connector 2 is adapted for connecting the USB port of a computer, hub, or any of a variety of electronic apparatus, having a jack 21 adapted for receiving the first connector 11 of the charging cable 1. Further, the USB connector 2 comprises a rectifying circuit adapted to rectify power supply received from USB port of the computer to which the USB connector 2 is inserted into a voltage level acceptable to the mobile telephone to be charged.

When in use, the first connector 11 and second connector 12 of the charging cable 1 are respectively connected to the jack 21 of the USB connector 2 and the power jack of the mobile telephone to be charged, and then the USB connector 2 is connected to the USB port of, for example, a computer, enabling the power supply of the computer to be rectified to the voltage level acceptable to the mobile telephone and then transmitted through the charging cable 1 to charge the mobile telephone.

A prototype of USB charging cable for mobile telephone has been constructed with the features of FIG. 1. The USB charging cable for mobile telephone functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A USB charging cable for mobile telephone comprising:
a USB connector adapted for connecting to the USB port of an electronic apparatus to receive power supply from said USB port and to rectify said power supply into a voltage level acceptable to a mobile telephone, said USB connector having a jack for power output; and
a charging cable adapted for connecting said USB connector to a mobile telephone to charge the mobile telephone, said charging cable comprising a first connector disposed at one end thereof and adapted for connecting to the jack of said USB connector to receive output power supply from said USB connector, and a second connector disposed at an opposite end thereof and adapted for connecting to the power jack of a mobile telephone to charge the mobile telephone with the power supply outputted from said USB connector.
